(19) United States
(12) Patent Application Publication
(10) Pub. No.: US 2025/0391168 A1
(43) Pub. Date: Dec. 25, 2025

(54) ALGORITHM AND METHODS FOR AUTOMATION OF OFFSIDE DECISIONS

(71) Applicant: HAMAD BIN KHALIFA UNIVERSITY, Doha (QA)

(72) Inventors: Samir Brahim Belhaouari, Doha (QA); Abdul-Rahman Abdel-Fattah, Doha (QA); Ashhadul Islam, Doha (QA)

(21) Appl. No.: 19/239,043

(22) Filed: Jun. 16, 2025

Related U.S. Application Data
(60) Provisional application No. 63/662,917, filed on Jun. 21, 2024.

(51) Int. Cl. G06V 20/40; G06T 7/20; G06T 7/70; G06V 20/70

(52) U.S. Cl. CPC G06V 20/42; G06T 7/20; G06T 7/70; G06V 20/70; G06V 2201/07

(57) ABSTRACT

Example systems, methods, and apparatus are disclosed herein for the automation of offside decisions. A smart video assistant referee (SMART VAR) is provided for the processing of streams of sequential images from a video of a football game for a real-time determination of whether an offside infraction has occurred. The SMART VAR uses coordinates of the left-most and right-most player of each opposing team, as well as the coordinates and direction of movement of the ball to determine whether a player is in an offsides position and whether an offside infraction has occurred as a result.

### PRIORITY CLAIM

This application claims priority to and the benefit of U.S. Provisional Pat. App. No. 63/662,917, filed Jun. 21, 2024, titled ALGORITHM AND METHODS FOR AUTOMATION OF OFFSIDE DECISIONS, the entire contents of which are incorporated by reference herein in their entirety and relied upon.

### BACKGROUND

The use of technology in football games has recently been a topic of interest. Specifically, the use of Artificial Intelligence to aid in the implementation of game rules is a developing field.

Offside calls are among the most contested and impactful decisions in modern football. Manual replay review often yields inconsistent interpretations and can take up to 10 seconds, disrupting match flow. Semi-automated line-drawing solutions reduce some delay but still depend on operator input and do not provide an end-to-end automated decision.

For instance, Video Assistant Referee (VAR) systems have become standard in elite football competitions to reduce human error in critical decisions, especially offside calls. Traditional VAR relies on manual frame tagging and line drawing, which can introduce delays and subjective bias. Recent semi-automatic tools still require human intervention for line placement and judgment.

Some examples of systems proposed and/or implemented include the use of chips in the football as well as on the players' persons to determine the relative position of each on the pitch. Besides the logistical issues involved in providing the chips on appropriate places on the players' bodies, determination of the offsides can take up to three minutes, and determination of ball placement is imprecise.

A need therefore exists for a robust, real-time system that autonomously calibrates field geometry, tracks all relevant actors, and computes offside status without human adjustment.

### SUMMARY

Example systems, methods, and apparatus are disclosed herein for an algorithm and methods for automation of offside decisions. Further, a system for smart automation of offside decisions using VAR implementing the systems, methods, and apparatus are disclosed. Such systems may be referred to herein as “SMART VAR”.

SMART VAR advances the state of the art by fully automating the offside decision, improving accuracy, consistency, and speed while maintaining compliance with IFAB offside laws.

In light of the disclosure herein, and without limiting the scope of the invention in any way, in a first aspect of the present disclosure, which may be combined with any other aspect listed herein unless specified otherwise, a smart video referee system is provided. The system comprises at least one camera, a memory, an alert device, and a smart video assistant referee device. The smart video referee device comprises a server in communication with the at least one camera, the memory, and the alert device, an object detection module, an image processing module, an image annotation module, and an alert module. The camera is configured to provide a plurality of sequential images from captured video to the smart video assistant referee, the object detection module is configured to detect at least one object in each image of the plurality of sequential images, the image processing module is configured to determine the identity of the at least one object using computer vision techniques, the image annotation module is configured to annotate each of the at least one object with at least one of a position and a direction of travel of the at least one object, and the smart video assistant referee utilizes an offside determination algorithm to determine, using the at least one of position and direction of travel of the at least one object, whether an offside infraction has occurred.

In a second aspect of the present disclosure, which may be combined with any other aspect listed herein unless specified otherwise, if an offside infraction is determined to have occurred, the smart video assistant referee is configured to send an alert via the alert module to the alert device.

In a third aspect of the present disclosure, which may be combined with any other aspect listed herein unless specified otherwise, the alert device is a device transported on the person of a referee.

In a fourth aspect of the present disclosure, which may be combined with any other aspect listed herein unless specified otherwise, the alert device is a screen of a stadium.

In a fifth aspect of the present disclosure, which may be combined with any other aspect listed herein unless specified otherwise, the alert device is a device transported on the person of at least one of a coach and a team member.

In a sixth aspect of the present disclosure, which may be combined with any other aspect listed herein unless specified otherwise, the alert device is a television screen of a remote viewer of a broadcast of a sporting event.

In a seventh aspect of the present disclosure, which may be combined with any other aspect listed herein unless specified otherwise, the object detection module employs YOLOv8 for object detection.

In an eighth aspect of the present disclosure, which may be combined with any other aspect listed herein unless specified otherwise, the image processing module employs OpenCV for image processing.

In a ninth aspect of the present disclosure, which may be combined with any other aspect listed herein unless specified otherwise, the image annotation module employs Roboflow for image annotation.

In a tenth aspect of the present disclosure, which may be combined with any other aspect listed herein unless specified otherwise, the offside infraction is an offside infraction of a football game.

In an eleventh aspect of the present disclosure, which may be combined with any other aspect listed herein unless specified otherwise, the offside infraction is an offside infraction of an American football game.

In a twelfth aspect of the present disclosure, which may be combined with any other aspect listed herein unless specified otherwise, the offside infraction is an offside infraction of an ice hockey game.

In a thirteenth aspect of the present disclosure, which may be combined with any other aspect listed herein unless specified otherwise, a method for the automation of offside decisions is disclosed. The method comprises providing a smart video assistant referee including an object detection module, an image processing module, and an image annotation module, providing a stream of sequential images captured from a video of a sports game to the smart video assistant referee, processing each image of the stream of sequential images through the object detection module, the image processing module, and the image annotation module, and running an offside determination algorithm on each processed image to determine whether an offside infraction has occurred.

In a fourteenth aspect of the present disclosure, which may be combined with any other aspect listed herein unless specified otherwise, the method further comprises, upon determining that an offside infraction has occurred, causing an alert to be sent to an alert device.

In a fifteenth aspect of the present disclosure, which may be combined with any other aspect listed herein unless specified otherwise, the alert device is at least one of a device transported on the person of a referee, a screen of a stadium, a device transported on the person of at least one of a coach and a team member, and a television screen of a remote viewer of a broadcast of a sporting event.

In a sixteenth aspect of the present disclosure, which may be combined with any other aspect listed herein unless specified otherwise, the object detection module employs YOLOv8 for object detection.

In a seventeenth aspect of the present disclosure, which may be combined with any other aspect listed herein unless specified otherwise, the image processing module employs OpenCV for image processing.

In an eighteenth aspect of the present disclosure, which may be combined with any other aspect listed herein unless specified otherwise, the image annotation module employs Roboflow for image annotation.

In a nineteenth aspect of the present disclosure, which may be combined with any other aspect listed herein unless specified otherwise, the offside infraction is an offside infraction of a football game.

In a twentieth aspect of the present disclosure, which may be combined with any other aspect listed herein unless specified otherwise, the offside infraction is an offside infraction of at least one of an American football game and an ice hockey game.

In light of the present disclosure and the above aspects, it is therefore an advantage of the present disclosure to provide users with a method and system for the automation of offside decisions is disclosed.

The present disclosure includes the following advantages:
(i) enhanced fairness and consistency: by automating offside decisions in real-time, the disclosed systems, methods, and apparatus minimize human bias and interpretation errors, leading to more equitable outcomes on the pitch;
(ii) improved game flow: by coming up with an automated offside detection system, interruptions are brief-preserving the match's natural rhythm and improving viewer engagement both in-stadium and via broadcast; and
(iii) data-driven insights: the system's continuous logging of positional and decision data creates a rich dataset for coaching analytics, performance benchmarking, and retrospective rule analysis by officiating bodies.

Additional features and advantages are described in, and will be apparent from, the following Detailed Description. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE DRAWINGS

FIG. 1 shows an example of player detection from a still image for the SMART VAR system, according to an example embodiment of the present disclosure.

FIG. 2 shows an example of pose estimation for the SMART VAR system, according to an example embodiment of the present disclosure.

FIG. 3 shows an example schematic diagram for the SMART VAR system, according to an example embodiment of the present disclosure.

FIG. 4 shows an example flowchart for a system process for the SMART VAR system, according to an example embodiment of the present disclosure.

FIG. 5 shows an example flowchart for an algorithm for determining an offsides call for a SMART VAR system, according to an example embodiment of the present disclosure.

FIG. 6 shows an example schematic diagram for the SMART VAR system, according to another embodiment of the present disclosure.

### DETAILED DESCRIPTION

Methods, systems, and apparatus are disclosed herein for an algorithm for the automation of offside decisions.

While the example methods, apparatus, and systems are disclosed herein for an algorithm for the automation of offside decisions, it should be appreciated that the methods, apparatus, and systems may be operable for other applications.

The present disclosure proposes an algorithm for the automation of offside decisions. Specifically, the disclosure is directed to systems, methods, apparatus for a computer vision system utilizing an object detection model to automate the detection of offside infractions in football matches. In some embodiments, the SMART VAR utilizes a commercially available object detection algorithm or model. For example, the SMART VAR integrates the YOLOv8 (You Only Look Once version 8) object detection model developed by Ultralytics.

The SMAR VAR includes the features of image processing and computer vision; player and ball tracking; offside rule interpretation; an offside detection algorithm; and real-time decision making. These features are integrated into a system capable of determining an offsides offense in a football game, as described in further detail below, in a preferred embodiment.

Regarding image processing and computer vision, the SMART VAR system utilizes each frame of a video feed in image processing techniques to extract relevant information. Computer vision algorithms are employed to analyze the video frames, identifying, and tracking the positions of players and the ball throughout the match. An image processing library is integrated into the SMART VAR in order to perform image processing and computer vision operations. In some embodiments, an open source image processing library is used to perform these operations. For example, the SMART VAR integrates the open source OpenCV computer vision library operated by Open Source Vision Foundation.

Regarding player and ball tracking, using object detection and tracking algorithms, the software of the SMART VAR identifies and tracks individual players and the ball in real-time. Moreover, tracking algorithms maintain continuous updates of player positions and ball movement across frames, ensuring accurate tracking throughout the match. Six pieces of relevant information are collected: (i)-(iv) the positions of the Most Right and Most Left players of both teams (a total of four player positions); (v) the position of the ball; and (vi) the direction of the ball. Pose Estimation is used to detect and track the positions of the key body parts to be used in the judgement of the offside decision (shoulder, knee, foot).

Regarding offside rule interpretation, the SMART VAR incorporates the rules of offside in football, including the position of the second-last opponent and the timing of the ball being played to the player in question. The SMART VAR is able to be updated according to changes in the rules or interpretation of rules. For instance, certain governing bodies or leagues may have different rules or interpretation of the rules relating to offsides than their international counterparts. The SMART VAR then uses this rule knowledge to determine potential offside situations based on the tracked positions of players and the ball. The rules governing offside for purposes of the below embodiments will implement the International Football Association Board (IFAB) governing laws, specifically Law 11.1: Offside, at the time of filing of this disclosure, in order to describe example implementations of the SMART VAR. It will be appreciated that the SMART VAR may be adapted to determine rules offenses for versions of offsides rules different than those described in the examples below, and further may be adapted to detect infractions from different rules or different sports altogether. For instance, the SMART VAR may be adapted to detect an offsides offense or false start offense in American football, an offsides offense in hockey, or any other sport offense, especially those relating to player position relative to ball or puck movement.

Regarding the offside detection algorithm, the SMART VAR employs a sophisticated offside detection algorithm that analyzes the relative positions of players, the ball, and the second-last opponent. By comparing the positions of these key elements at the moment the ball is played to a player, the algorithm of the SMART VAR determines whether the player is in an offside position.

Finally, regarding real-time decision making, when the offside detection algorithm identifies a potential offside infraction, the SMART VAR generates a real-time alert or notification. In some embodiments, the alert can be relayed to referees or officiating officials on the field and/or in an observational booth, providing them with immediate information to make on-the-spot decisions regarding offside calls during the match. The SMART VAR systems, methods, and apparatus are not necessarily intended to replace officiating crews. The SMART VAR can be used solely as an aid in officials' determinations or can be used as a replacement for certain officiating decisions within the game.

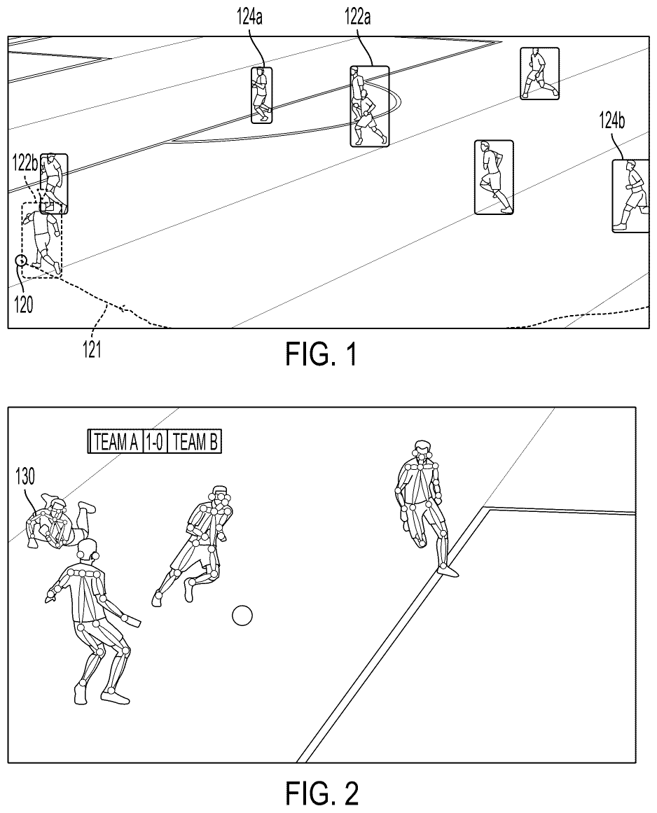

Turning now to FIG. 1, an example implementation of object detection implemented by the SMART VAR is illustrated. This example shows object detection, specifically player detection, ball detection, and ball movement direction detection. The left-most player on the attacking team 122a and the right-most player on the attacking team 122b, as well as the left-most player on the defending team 124a and the right-most player on the defending team 124b within the frame are recognized using the YOLOv8 object detection model, which creates a box around each player's body. The current position of the ball 120 and the direction of motion of the ball 121 are also detected using the object detection model.

Creating a box around each player's body allows the SMART VAR to estimate a position of each player's body and extremities relative to the position on the pitch within the frame, and therefore to each other player. In this embodiment, the positions of player extremities are estimated based on the outermost portion of each box (i.e. the top of a player's head is at the top of the box, a player's wrist is at one side of a box, etc.). This embodiment may be especially useful in sports applications where offside rules state that no part of a player's body may be beyond a certain point (e.g. American football, hockey, and certain football leagues).

In the embodiment of FIG. 2, pose estimation is performed by looking for individual player body parts and creating a vector set 130 for each player. Such a vector set 130 allows for accurate detection of specific body parts (such as a wrist, ankle, head, etc.), and therefore may be more useful for certain sports applications where offside rules delineate between body parts (e.g. the current IFAB offside rules, which state that the hands and arms of all players are not considered in an offsides determination). The embodiment of FIG. 1 may also be used for this purpose by estimation, even if some inaccuracies are imported due to the estimation.

The embodiments of either FIG. 1 or FIG. 2 may also be helpful in proposed rule changes at the IFAB which include a determination of “daylight” or a gap between an attacking player and the second-to-last defending player. The data collected in either embodiment is suitable for giving an exact distance between players to determine if a gap or “daylight” exists and may be better suited for repeatability of this concept than from a human referee alone.

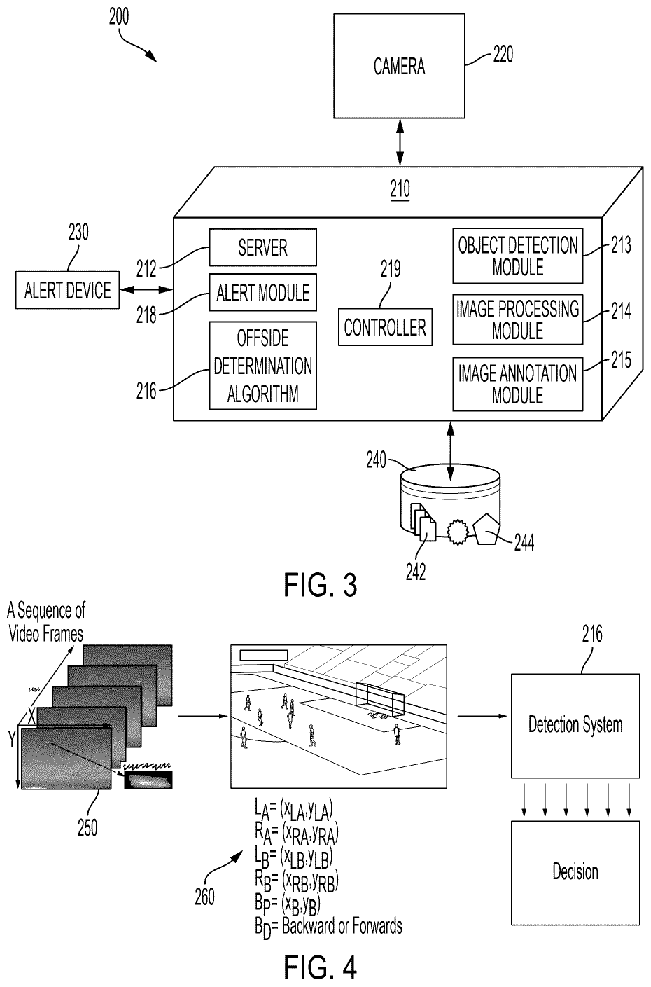

Turning now to FIG. 3, the SMART VAR system 200 will be described in further detail. The SMART VAR system 200 includes a SMART VAR 210 including a server 212. The server 212 is configured to provide communication with at least one camera 220, at least one alert device 230, and at least one memory 240. In some embodiments, the memory 240 is integrated into the SMART VAR 210. The camera 220 maybe a main feed camera of the broadcast of the sporting event or any camera 220 which is currently being used in the broadcast. In alternative embodiments, a separate camera 220 is employed which is dedicated to the SMART VAR system 200. The camera 220 is configured to send a rolling stream of images to the SMART VAR 210. This stream is typically given at a rate of about 30 fps (frames per second), but may also be a slow-motion video stream (for example, at a rate of about 240 fps or greater).

The SMART VAR 210 receives the rolling stream of images and delivers the images sequentially to the object detection module 213, the image processing module 214, and the image annotation module 215. The SMART VAR 210 in one embodiment sends each image to the object detection module 213, the image processing module 214, and the image annotation module 215 in series, such that the image processing module 214 receives an image which has already gone through object detection and the image annotation module 215 receives an image which has already gone through object detection and image processing. In other embodiments a different order of the series of the object detection module 213, the image processing module 214, and the image annotation module 215 may be used. In alternative embodiments, the SMART VAR 210 sends a copy of each image to each of the object detection module 213, the image processing module 214, and the image annotation module 215 in parallel, and a final image is compiled from the images resulting from the parallel operations of the object detection module 213, the image processing module 214, and the image annotation module 215. Reception and management of the images within the SMART VAR 210 may be performed by a controller 219 in the SMART VAR 210.

In some embodiments the object detection module 213 includes the YOLOv8 object detection model, the image processing module 214 includes the OpenCV image processing model, and the image annotation module 215 includes the Roboflow image annotation model.

Once an image has undergone the operations of the object detection module 213, the image processing module 214, and the image annotation module 215, a final image is presented to the offside determination algorithm 216. The offside determination algorithm 216 uses the information provided by the object detection module 213, the image processing module 214, and the image annotation module 215 to make a determination of whether an offsides infraction has occurred, as described in further detail in the description of FIG. 4. The offside determination algorithm 216 delivers a result of a yes or a no for whether an offsides infraction has occurred.

In the case that an offside infraction is determined to have occurred by the offside determination algorithm 216, the SMART VAR 210 causes the alert module 218 to provide an alert to an alert device 230. The SMART VAR 210 may use a controller 219 to cause the alert module 218 to deliver the alert. The alert may be communicated via the server 212 which allows communication between the alert device 230 and the SMART VAR 210. In some embodiments the alert module 218 sends an alert to one or more of the referees where the alert device 230 is a handheld alert device on the person of the referee. The referees may include any of the referees on the pitch and/or those in a remote reviewing location. In some alternative embodiments, the alert is displayed on a screen at the stadium as the alert device 230 such that the referees, players, and fans are all able to see when an offside infraction has occurred. In further alternative embodiments, an alert is sent to the coaching staff to aid in determining whether to challenge the call or lack of call of an offside infraction. In some embodiments, the alert device 230 includes an LED, a vibration on a handheld device, a noise, and/or a display on a screen such as a screen of a handheld device, a screen of a stadium, or a screen of a fan such as in a broadcast.

In some embodiments, the SMART VAR system 200 is configured to illustrate where an offside offense has occurred. For example, the SMART VAR system 200 may include a laser or concentrated light which shines at a physical location on the pitch where the infraction occurred so that the players can visualize where the ball needs to be placed and the game can continue with the least possible interruption of game flow. In other embodiments, a location on the pitch is illustrated in a graphical user interface as superimposed on a photographic or digital representation of the pitch.

The SMART VAR system 200 may also include a memory 240 storing logs 242 of images after operation of the object detection module 213, the image processing module 214, and the image annotation module 215, and with the associated determination from the offside determination algorithm 216. The memory 240 may also include its own graphical user interface (GUI) 244 that allows for user interaction with the SMART VAR 210. The memory 240 may also be employed to store intermediate versions of the images between each operation of the object detection module 213, the image processing module 214, and the image annotation module 215. In some embodiments, the memory 240 includes random access memory dedicated to storing intermediate versions of the images and sending the processed image to the offside determination algorithm 216. In some embodiments, the memory 240 is integrated within the SMART VAR 210.

In alternative embodiments, the entirety of the SMART VAR 210 and/or the memory 240 is integrated directly into the camera 220.

Turning to FIG. 4, a basic flowchart of the process involved for the SMART VAR 200 is disclosed in further detail. First, a series of images 250 from a camera video recording are provided to a SMART VAR. Each still image is rendered through one or more of the object detection module 213, the image processing module 214, and the image annotation module 215. Data points 260 are extracted from the rendering, including the position of the left-most player on the attacking team (L_{A}), the position of the right-most player on the attacking team (R_{A}), the position of the left-most player on the defending team (L_{B}), the position of the right-most player on the defending team (R_{B}), and the position of the ball (B_{P}), all of which are presented as a combination of an X-coordinate and a Y-coordinate. In some embodiments, the players identified exclude each team's goalie. Also included is a direction of the ball (B_{D}), which is presented as a binary (e.g. backward or forward, or positive or negative). These data 260 are delivered to the offside determination algorithm 216 (which in the embodiment of FIG. 4 is part of a detection system in the SMART VAR).

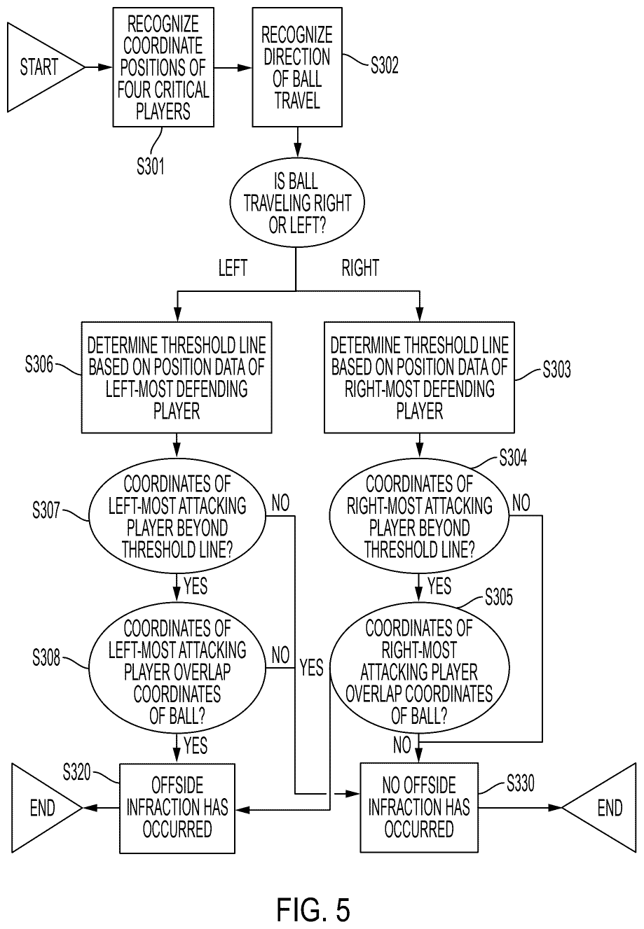

The offside determination algorithm then renders a decision of offsides or not offsides based on the offside determination algorithm 216 disclosed in the flowchart of FIG. 5, described in further detail here. Although one embodiment of the algorithm 216 is presented below, it will be appreciated that the algorithm 216 may be adapted as necessary to meet changing needs in the sport or to adapt the SMAR VAR system 200 to a different sport application. Further, steps in the algorithm 216 may be presented in a certain order in order to give an understanding of a working algorithm, but such steps and the order of such steps may be changed or adjusted as necessary or based on preferences of the user. The offside determination algorithm begins 300 when a processed image is presented to the offside determination algorithm, such as by the controller 219 of the SMAR VAR 210.

At a first step S301, the algorithm 216 recognizes the position of the left-most attacking player (X_{LA}, Y_{LA}), the position of the right-most attacking player (X_{RA}, Y_{RA}), the position of the left-most defending player (X_{LB}, Y_{LB}), and the position of the right-most defending player (X_{RB}, Y_{RB}). These four players may be deemed “critical” players for purposes of the SMART VAR system 200 because the determination of offsides will be made based primarily on these players. The algorithm 216 then, at a second step S302, recognizes a direction of travel of the ball. If the ball is traveling to the right, then the algorithm 216 proceeds to step S303, where the algorithm 216 determines a threshold line based on the position data of the right-most defending player. The threshold line is calculated in some embodiments by subtracting an angle of the camera 220 from 0 and imposing a line at that angle which intersects the coordinates of the right-most defending player. For example, if the camera 220 is perfectly straight on at the middle of the pitch, a vertical line would be superimposed at a location which intersects the coordinates of the right-most defending player (for example, at a distance of X_{RB} from the origin point imposed on the picture). On the other hand, if the camera is at an angle of 20° to the right from the midline, then a line at an angle of −20° from vertical is superimposed at a location which intersects the coordinates of the right-most defending player (for example, at a distance of X_{RB} from the origin point imposed on the picture) in order to compensate for the camera angle. In embodiments adapted for American football, the threshold line is placed at the position of the ball. The algorithm 216 then proceeds to step S304, where a determination is made as to whether the coordinates of the right-most attacking player are beyond (i.e. to the right of) the threshold line. If the coordinates of the right-most attacking player are not beyond the threshold line, then a determination of no offsides infraction S330 is made and the algorithm ends. If the coordinates of the right-most attacking player are beyond the threshold line, then this means the right-most attacking player is in an offsides position and the algorithm proceeds to step S305. Although a player may be in an offsides position, this does not mean an offside infraction has yet occurred, since an offside infraction in not incurred until the player in an offsides position comes in contact with the ball (or in the case of American football until the ball is snapped). At step S305, the algorithm 216 uses the coordinates of the ball to determine if any overlap between the ball coordinates and the coordinates of the right-most attacking player exists. In some embodiments, a threshold proximity between coordinates is used instead of a strict overlap of coordinates. If there is determined to be overlap, then this means an offside infraction has occurred and the algorithm proceeds to step S320 where the algorithm 216 returns a determination of an offside infraction having occurred. Otherwise, if there is determined to be no overlap or the ball is not within the threshold proximity of the right-most attacking player, then a determination of no offside infraction is made as step S330.

If the ball is traveling to the left, then the algorithm 216 proceeds to step S306, where the algorithm 216 determines a threshold line based on the position data of the left-most defending player. The algorithm 216 then proceeds to step S307, where a determination is made as to whether the coordinates of the left-most attacking player are beyond (i.e. to the left of) the threshold line. If the coordinates of the left-most attacking player are not beyond the threshold line, then a determination of no offsides infraction S330 is made and the algorithm ends. If the coordinates of the left-most attacking player are beyond the threshold line, then this means the left-most attacking player is in an offsides position and the algorithm proceeds to step S308. As noted above, although a player may be in an offsides position, this does not mean an offside infraction has yet occurred, since an offside infraction in not incurred until the player in an offsides position comes in contact with the ball (or in the case of American football until the ball is snapped). At step S308, the algorithm 216 uses the coordinates of the ball to determine if any overlap between the ball coordinates and the coordinates of the left-most attacking player exists. As noted above, in some embodiments, a threshold proximity between coordinates is used instead of a strict overlap of coordinates. If there is determined to be overlap, then this means an offside infraction has occurred and the algorithm proceeds to step S320 where the algorithm 216 returns a determination of an offside infraction having occurred. Otherwise, if there is determined to be no overlap or the ball is not within the threshold proximity of the left-most attacking player, then a determination of no offside infraction is made as step S330.

The SMART VAR system 200 will then use the determination to control the alert module 218 to provide an alert if a determination of an offsides infraction has been made. The determination may be stored as metadata along with the renderings made by the object detection module 213, the image processing module 214, and the image annotation module 215 in the image file and stored in the memory 240, such as in the file logs 242.

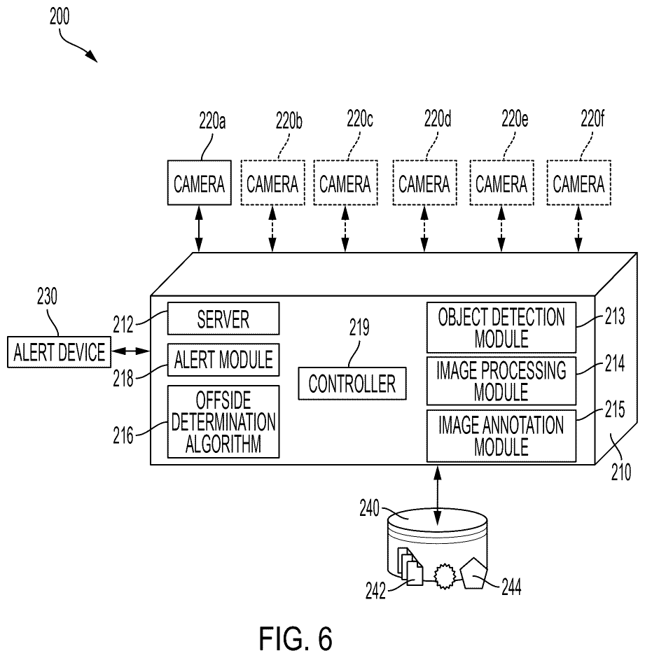

Turning now to FIG. 6, an alternative embodiment of the SMART VAR system 200 is illustrated. In this alternative embodiment, up to six cameras 220a-f are employed. In this embodiment, a separate camera 220a-f may be used to track each individual coordinate. For example the first camera 220a may be used to track the coordinates of the ball; the second camera 220b may be used to track a direction of travel of the ball; the third camera 220c may be used to track the position of the right-most attacking player; the fourth camera 220d may be used to track the position of the left-most attacking player; the fifth camera 220e may be used to track the position of the right-most defending player; and the sixth camera 220f may be used to track the position of the left-most defending player. In some embodiments, each camera 220a-f includes a separate server configured to cause the stream of images to be delivered to the SMART VAR 210. In some further embodiments, each camera 220a-f includes a separate object detection module 213, image processing module 214, and/or image annotation module 215, such that the images sent to the SMART VAR 210 have already gone through processing for the offside determination algorithm 216. Each camera in any embodiment may include a separate memory or store the images on the shared memory 240 of the SMART VAR system 200.

It should be appreciated that the SMART VAR system 200, and particularly the SMART VAR 210 includes all hardware and software components to run the object detection module 213, the image processing module 214, the image annotation module 215, and/or the offside determination algorithm 216, any of which may be stored in a memory (including the shared memory 240) as a non-transitory computer-readable medium.

### Test Data

Testing was performed on an initial version of SMART VAR to prove its applicability. Data was collected from several football games across various league competitions from different parts of the world. Both still images and videos were used as part of the data body. The data was then split into various categories. For instance, the body of data was split between 70% training of the SMART VAR, 15% validation data, and 15% testing data. OpenCV was used for image processing, YOLOv8 was used for object detection, and Roboflow was used for image annotation.

The system was initially tested on 240 video samples, and produced an accuracy of 83%, a precision of 85%, a F1-score 86%, and a recall of 87%. The confusion matrix for the initial results is presented below:

TABLE 1
Confusion matrix for results of initial tests

| | Predicted Not Offside | Predicted Offside |
|---|---|---|
| Actual Not Offside | 70 (TN) | 22 (FP) |
| Actual Offside | 18 (FN) | 130 (TP) |

Where TN = true negative, FN = false negative, FP = false positive, and TP = true positive.

Although some false positive and false negative results were detected, the initial testing proves that a SMART VAR system can be developed and improved with useful results even in the initial model.

### CONCLUSION

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A smart video assistant referee system, the system comprising:
at least one camera;
a memory;
an alert device; and
a smart video assistant referee device comprising:
a server in communication with the at least one camera, the memory, and the alert device;
an object detection module;
an image processing module;
an image annotation module; and
an alert module,
wherein the camera is configured to provide a plurality of sequential images from captured video to the smart video assistant referee,
wherein the object detection module is configured to detect at least one object in each image of the plurality of sequential images,
wherein the image processing module is configured to determine the identity of the at least one object using computer vision techniques,
wherein the image annotation module is configured to annotate each of the at least one object with at least one of a position and a direction of travel of the at least one object, and
wherein the smart video assistant referee utilizes an offside determination algorithm to determine, using the at least one of position and direction of travel of the at least one object, whether an offside infraction has occurred.

2. The system of claim 1, wherein if an offside infraction is determined to have occurred, the smart video assistant referee is configured to send an alert via the alert module to the alert device.

3. The system of claim 2, wherein the alert device is a device transported on the person of a referee.

4. The system of claim 2, wherein the alert device is a screen of a stadium.

5. The system of claim 2, wherein the alert device is a device transported on the person of at least one of a coach and a team member.

6. The system of claim 2, wherein the alert device is a television screen of a remote viewer of a broadcast of a sporting event.

7. The system of claim 1, wherein the object detection module employs YOLOv8 for object detection.

8. The system of claim 1, wherein the image processing module employs OpenCV for image processing.

9. The system of claim 1, wherein the image annotation module employs Roboflow for image annotation.

10. The system of claim 1, wherein the offside infraction is an offside infraction of a football game.

11. The system of claim 1, wherein the offside infraction is an offside infraction of an American football game.

12. The system of claim 1, wherein the offside infraction is an offside infraction of an ice hockey game.

13. A method for the automation of offside decisions, the method comprising:
providing a smart video assistant referee including an object detection module, an image processing module, and an image annotation module;
providing a stream of sequential images captured from a video of a sports game to the smart video assistant referee;
processing each image of the stream of sequential images through the object detection module, the image processing module, and the image annotation module; and
running an offside determination algorithm on each processed image to determine whether an offside infraction has occurred.

14. The method of claim 13, further comprising:
upon determining that an offside infraction has occurred, causing an alert to be sent to an alert device.

15. The method of claim 14, wherein the alert device is at least one of a device transported on the person of a referee, a screen of a stadium, a device transported on the person of at least one of a coach and a team member, and a television screen of a remote viewer of a broadcast of a sporting event.

16. The method of claim 13, wherein the object detection module employs YOLOv8 for object detection.

17. The method of claim 13, wherein the image processing module employs OpenCV for image processing.

18. The method of claim 13, wherein the image annotation module employs Roboflow for image annotation.

19. The method of claim 13, wherein the offside infraction is an offside infraction of a football game.

20. The method of claim 13, wherein the offside infraction is an offside infraction of at least one of an American football game and an ice hockey game.
